(19) United States
(12) Patent Application Publication
(10) Pub. No.: US 2002/0079043 A1
(43) Pub. Date: Jun. 27, 2002

(54) Pipe coating process

(76) Inventor: Glen R. Garneau, Nisku (CA)

Correspondence Address: THOMPSON LAMBERT, SUITE 703D, CRYSTAL PARK TWO, 2121 CRYSTAL DRIVE, ARLINGTON, VA, 22202

(21) Appl. No.: 09/742,357

(22) Filed: Dec. 22, 2000

(51) Int. Cl. B31C 1/00

(52) U.S. Cl. 156/184; 156/307.3

(57) ABSTRACT

Resin soaked fiberglass strands are applied to abrasively cleaned steel pipe to increase the hoop stress. Steel pipe that is abrasively cleaned is preheated and a primer coat is applied. Fiberglass strands that are soaked with heated resin are then applied in a helical method to the pipe to induce an accelerated cure of the resin. Followed by a polyethylene wrap to protect the ouside of the composite. Allowing the coated pipe to be driven over a conveyor line. This process is continuous in which the steel pipe is wrapped from end to end, on pipe that is connected with a come-along (steel or plastic).

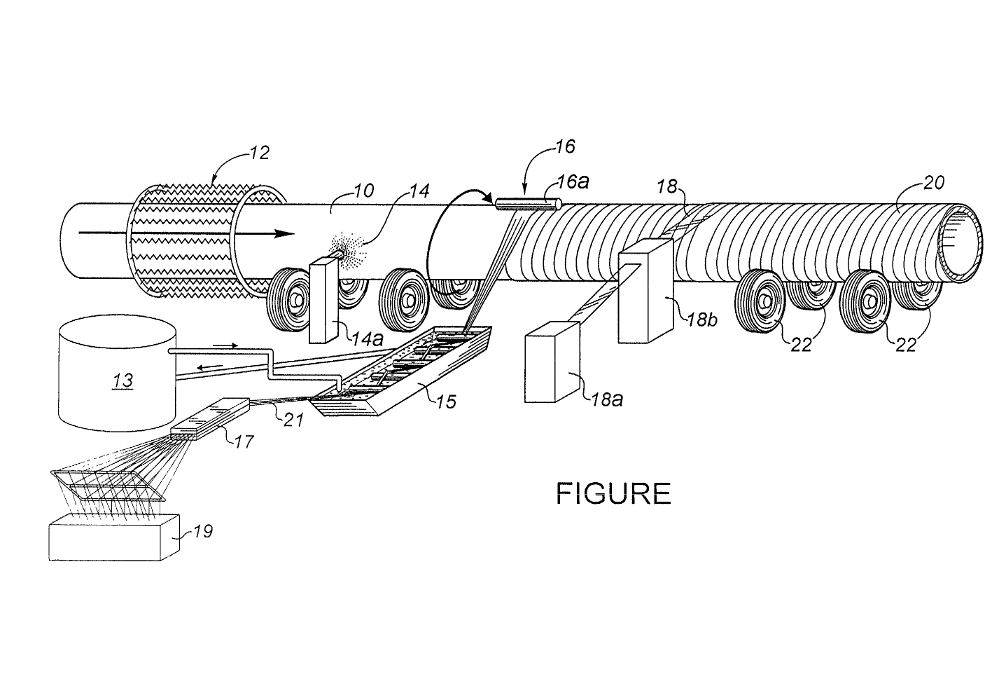

### FIELD OF THE INVENTION

This invention relates to processes for the coating of pipes.

### BACKGROUND OF THE INVENTION

Conventionally, fiber coating of pipes is carried out by winding a continuous resin soaked fiber bundle back and forth along a section of pipe until multiple layers of the fiber bundle are formed. Once one section of pipe is completed, another section is started. This is a time consuming process, and produces a relatively thick coating in a few passes. At the ends of the pipe, fibers of successive layers cross-over each other, resulting in stress points in the fiber bundle. This method is not practical for coating long sections of pipe.

### SUMMARY OF THE INVENTION

It is an object of the present invention to provide a method for applying resin soaked fiber strands to surface treated pipe to increase the hoop stress, which is t the maximum operating pressures of the steel pipe.

It is also an object of the invention to provide a method for accelerating the cure of the resin by heating the pipe, fiber and resin in order to increase the production rate.

There is therefore provided in accordance with an aspect of the invention, a method for coating pipe. A pipe is first surface treated, such as by abrasive cleaning and application of primer, to enhance adhesion of the pipe surface to resin soaked fibers. Resin soaked fibers are continuously wound in a helical fashion onto the surface treated pipe to form a continuous pipe coating made up of multiple layers of the resin soaked fibers. The resin is then cured, preferably heat cured. Preferably, the pipe, resin, primer and fibers are all preheated before winding the resin soaked fibers onto the pipe to a temperature that promotes curing of the resin. The composite pipe thus formed is preferably coated with a film, such as polyethylene or other thermosetting plastic film before curing.

The resin soaked fibers are preferably arranged into a web before being wound onto the pipe. The web is preferably formed of a single layer of parallel fibers and the web is advanced along the pipe in a spiral with sufficient overlap between adjacent flights of the spiral to produce multiple layers of resin soaked fibers.

These and other aspects of the invention are described in the detailed description of the invention and claimed in the claims that follow.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which the figure shows a schematic of a process for carrying out a method according to the invention.

### DETAILED DESCRIPTION OF PREFERRED EMBODIMENTS

In this patent document, “comprising” means “including”. In addition, a reference to an element by the indefinite article “a” does not exclude the possibility that more than one of the element is present. The word “continuously” is used in the claims to indicate that a pipe made of several sections is being continuously coated, without pausing to allow resin to cure on a particular section of pipe.

The invention provides an improved accelerated method for curing and applying resin soaked fiberglass strands to an abrasively cleaned steel substrate to increase the hoop stress. First, the steel substrate of the pipe 10 is abrasively cleaned with a blast media to a near white sspc-sp10 finish, anchor pattern 40-100 microns. The substrate is preheated at heating unit 12 to 215-235° F. and a primer layer 14 of 0.001-0.003″ is applied using a conventional primer applicator 14a at 65-75° F. just to cover the surface.

Resin is mixed with catalyst and preheated in resin tank 13. The resin is selected in accordance with principles generally known in the art of composite manufacture for the intended application. The resin is delivered to a soaking trough 15 where the preheated fiberglass strands are dragged through at high velocities The fiberglass strands are preheated at preheat unit 19 before use and additional heating comes prior to the soaking trough at a waffle iron 17. The resin is preheated to 100-120° F. in the tank 13 and is delivered to the soaking trough as a web 21 of heated fiberglass strands. The web 21 is formed of wide band-single layer parallel strands pre-heated to at least 120-150° F. prior to soaking. The web 21 of strands is dragged through at high speeds (150-600 ft/min). These resin soaked fiberglass strands are wrapped helically to the steel substrate to form a composite coated pipe. The pipe travels on a conveyor line at set angle of travel per rpm. The preheated primered pipe 10 is externally wrapped in multiple helical layers of heated resin soaked fiberglass strands at wrapping unit 16 and squeegeed by squeegees 16a & 16b to remove excess resin to insure the correct resin to glass ratio in accordance with known principles for composite manufacture. Surplus resin may be reclaimed at the end of the trough 15 and returned to the resin tank 13. The web 21 is applied to the pipe 10 at an angle that results in adjacent flights of the resulting helical wrap overlapping, such that a desired number of layers, for example 12 or more, may be formed.

This combination of heated pipe, primer, resin, and fiberglass causes the resin to setup (cure) extremely quickly as compared with room temperature cure. While composite is being wound onto the pipe at wrapping unit 16, a heated film 18 is wrapped onto the coated pipe at a wrapping unit 18b sufficiently downstream in the process that a set time period (less than about 2 minutes for the example described here) has elapsed between coating and film wrapping. The exterior of the composite is wrapped with polyethylene or equivalent thermo-setting plastic film 18 while the composite is still tacky on the surface. This heated film 18 cures the resin from the heat of the polyethylene, which may be at 200° C. or more, the higher the better, and as high as the polyethylene will permit. The film is produced as a sheet of polyethylene 18 produced from a extruder 18a. The film wrap allows the end product to be driven on conveyor wheels 22.

The composite coated pipe 20 is driven over wheels 22 on a conventional pipe conveyor line. This process allows the steel pipe 20 to be advanced continuously by the conveyor line, with the pipe sections joined via conventional come-alongs 24. The composite is wrapped from end to end pipe after pipe. The produced composite coated pipe may be tested for glass to resin ratio, percentage of void (air pockets) content, hardness inside and outside and percentage of cure of resin in a differential scanning calorimeter.

The use of the continuous coating process including resin soaked fiber supply unit (elements 13, 15, 17 and 19), pipe heating unit 12, primer applicator 14a and film wrapping unit 18b may all be installed easily as a stand alone unit in a coating plant. The modularized system allows simple set up and control of the individual units making up the continuous coating process. Resin tanks, waffle irons, fiber strand supply, soaking troughs, film extruders and applicators, primer applicators, pipe rotation equipment, squeegees and abradors are all known in themselves in the art of pipe coating and do not need to be further described here.

Immaterial modifications may be made to the invention described here without departing from the essence of the invention.

The embodiments of the invention in which an exclusive property or privilege is claimed are defined as follows:

1. A method for coating pipe, comprising the steps of:
surface treating a pipe to enhance adhesion of the pipe surface to resin soaked fibers;
continuously winding resin soaked fibers in a helical fashion onto the surface treated pipe to form a continuous pipe coating made up of multiple layers of the resin soaked fibers; and
curing the resin.

2. The method of claim 1 in which the pipe is heated before winding the resin soaked fibers onto the pipe to a temperature that promotes curing of the resin.

3. The method of claim 2 in which the resin soaked fibers are heated before winding the resin soaked fibers onto the pipe to a temperature that promotes curing of the resin.

4. The method of claim 1 in which surface treating the pipe comprising roughening the pipe surface.

5. The method of claim 4 in which surface treating the pipe comprises applying a primer to the pipe surface.

6. The method of claim 1 in which the resin soaked fibers are coated with a heated film to enhance curing.

7. The method of claim 6 in which the film is a thermal setting plastic film.

8. The method of any one of the preceding claims in which the resin soaked fibers are arranged into a web before being wound onto the pipe.

9. The method of claim 8 in which the web is formed of a single layer of parallel fibers and the web is advanced along the pipe in a spiral with sufficient overlap between adjacent flights of the spiral to produce multiple layers of resin soaked fibers.

10. A method for coating pipe, comprising the steps of:
surface treating a pipe to enhance adhesion of the pipe surface to resin soaked fibers;
winding a single layered web of resin soaked fibers in a helical fashion onto the surface treated pipe to form a pipe coating made up of multiple layers of the resin soaked fibers; and
curing the resin.

11. The method of claim 10 in which the web is formed of parallel fibers and the web is advanced along the pipe in a spiral with sufficient overlap between adjacent flights of the spiral to produce multiple layers of resin soaked fibers.

12. The method of claim 11 in which the pipe is heated before winding the resin soaked fibers onto the pipe to a temperature that promotes curing of the resin.

13. The method of claim 12 in which the resin soaked fibers are heated before winding the resin soaked fibers onto the pipe to a temperature that promotes curing of the resin.

14. The method of claim 13 in which surface treating the pipe comprising roughening the pipe surface.

15. The method of claim 14 in which surface treating the pipe comprises applying a primer to the pipe surface.

16. The method of claim 15 in which the resin soaked fibers are coated with a heated film to enhance curing.
